(19) United States
(12) Patent Application Publication
(10) Pub. No.: US 2022/0171907 A1
(43) Pub. Date: Jun. 2, 2022

(54) CREATION OF DIGITAL TWIN OF THE INTERACTION AMONG PARTS OF THE PHYSICAL SYSTEM

(71) Applicant: Siemens Aktiengesellschaft, Munich (DE)

(72) Inventors: Ti-chiun Chang, Princeton Junction, NJ (US); Pranav Srinivas Kumar, Nashville, TN (US); Reed Williams, Princeton, NJ (US); Arun Innanje, Dayton, NJ (US); Janani Venugopalan, Plainsboro, NJ (US); Edward Slavin, III, Robbinsville, NJ (US); Lucia Mirabella, Plainsboro, NJ (US)

(21) Appl. No.: 17/437,872

(22) PCT Filed: Mar. 18, 2019
(86) PCT No.: PCT/US2019/022672

§ 371 Date: Sep. 10, 2021

(51) Int. Cl. G06F 30/27; G05B 19/418; G06N 3/04

(52) U.S. Cl. CPC G06F 30/27; G06F 2119/18; G06N 3/04; G05B 19/41885

(57) ABSTRACT

A method includes receiving, via a first component in a production environment, a sensor measurement corresponding to a second component in the production environment. A first digital twin corresponding to the first component is identified, and a perception algorithm is applied to identify a component type associated with the second component. A second digital twin is selected based on the component type, and a third digital twin is selected that models interactions between the first digital twin and the second digital twin. The third digital twin is used to generate instructions for the first component that allow the first component to interact with the second component. The instructions may then be delivered to the first component.

### TECHNICAL FIELD

The present disclosure relates generally to methods, systems, and apparatuses related to the creation and use of a digital twin to model interactions between system components. The disclosed techniques may be applied to, for example, manage interactions in automated or semi-automated systems such as factories or self-driving vehicles.

### BACKGROUND

For a complex physical system, it is important to understand how different components interact to complete a task, especially under unknown circumstances. Most physical systems, such as a robot, are designed to achieve a predetermined task. As the robot becomes more powerful and intelligent, it can also operate in unknown situations. For example, a human can try to lift an object that is never seen before. He or she may use one hand to lift it first. Finding that it is too heavy, 2 hands and even shoulder, waist, or leg would join to help. A machine does not have perception. It has to evaluate the new situation by first understanding and then simulation, and to plan for interaction among its parts, much like a human does.

For individual components, a digital twin offers one way of understanding how the real-world component reacts under different scenarios. Briefly, a digital twin is a digital version of a machine. Once created, the digital twin can be used to represent the machine in a digital representation of a real world system. The digital twin is created such that it is identical in form and behavior of the corresponding machine. Additionally, the digital twin may mirror the status of the machine within a greater system. For example, sensors may be placed on the machine to capture real-time (or near real-time) data from the physical object to relay it back to a remote digital twin. The digital twin can then make any changes necessary to maintain its correspondence to the physical twin.

Although digital twins offer a great deal of information relevant to a single device, there is currently no way to view, manage, and use data relevant to interactions between devices such as the tasks described above.

### SUMMARY

Embodiments of the present invention address and overcome one or more of the above shortcomings and drawbacks, by providing methods, systems, and apparatuses related to the creation and use of a digital twin to model interactions between system components.

According to some embodiments, a method includes receiving, via a first component in a production environment, a sensor measurement corresponding to a second component in the production environment. A first digital twin corresponding to the first component is identified, and a perception algorithm is applied to identify a component type associated with the second component. A second digital twin is selected based on the component type, and a third digital twin is selected that models interactions between the first digital twin and the second digital twin. The third digital twin is used to generate instructions for the first component that allows the first component to interact with the second component. The instructions may then be delivered to the first component.

According to other embodiments, a system comprises three digital twins. A first digital twin corresponds to a first component in a production environment, and a second digital twin corresponds to a second component in the production environment. The third digital twin models interactions between the first component and the second component using the first digital twin and the second digital twin.

According to other embodiments, a system for modeling interactions between a first component and a second component in a production environment includes: a perception module, a digital twin selection module, an interaction digital twin, and an optimization module. The perception module receives sensor data from the first component and identifying the second component based on the sensor data. The digital twin selection module selects a first digital twin corresponding to the first component and second digital twin corresponding to the second component. The interaction digital twin models interactions between the first component and the second component using the first digital twin and the second digital twin. The optimization module identifies an optimal interaction between the first and second component using the interaction digital twin.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1A provides a simple example where a robot is tasked with picking up a box off a conveyor belt;

FIG. 1B provides an overview of the interaction of system components which can be modeled using digital twins, according to some embodiments;

FIG. 2 illustrates an example of interaction digital twin, according to some embodiments;

FIG. 3 illustrates an example method for modeling interactions, according to some embodiments; and

FIG. 4 illustrates an exemplary computing environment within which the task planning computer may be implemented.

### DETAILED DESCRIPTION

Systems, methods, and apparatuses are described herein which relate generally to the creation of digital twin of the interaction among parts of the physical system. The techniques described herein design and exploit machine perceptual systems to understand the context of the parts of the physical system. Innovative computer vision technologies are utilized for physical 3D scene semantic understanding. Each object that is involved in the system is recognized. Furthermore, the dynamics of any moving object can be predicted. Based on the collected information, the simulated environment in the digital world (i.e., the digital twin) can be created. The physical modeling of all of the objects is conducted much like in a computer game, except that the parameters are calculated and estimated from the physical world. However, the same components in the scene, subject to the same individual dynamics would behave differently when interacting together.

Briefly, the techniques described herein use data acquired from the same multi-components physical system under different situations (e.g., component 1 pushing on component 2 in a certain position, component 1 and component 3 departing from each other without contact . . . ) to learn the nature of the interaction between the components. Once the interaction is learned, (e.g., form of rule based system), a simulation using the learned interaction model could be used to predict ahead of the physical world and then use the measured physical interaction among parts or objects to calibrate the simulation for predicting the next time instance.

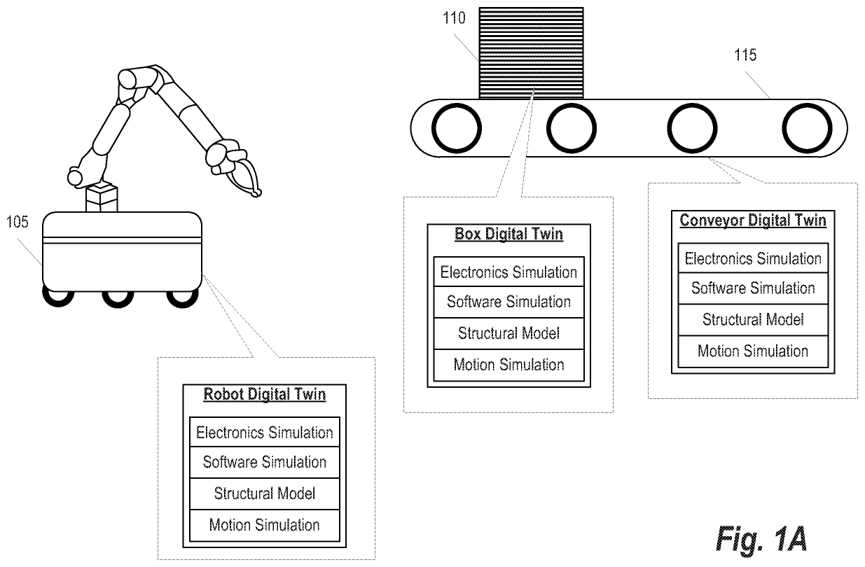

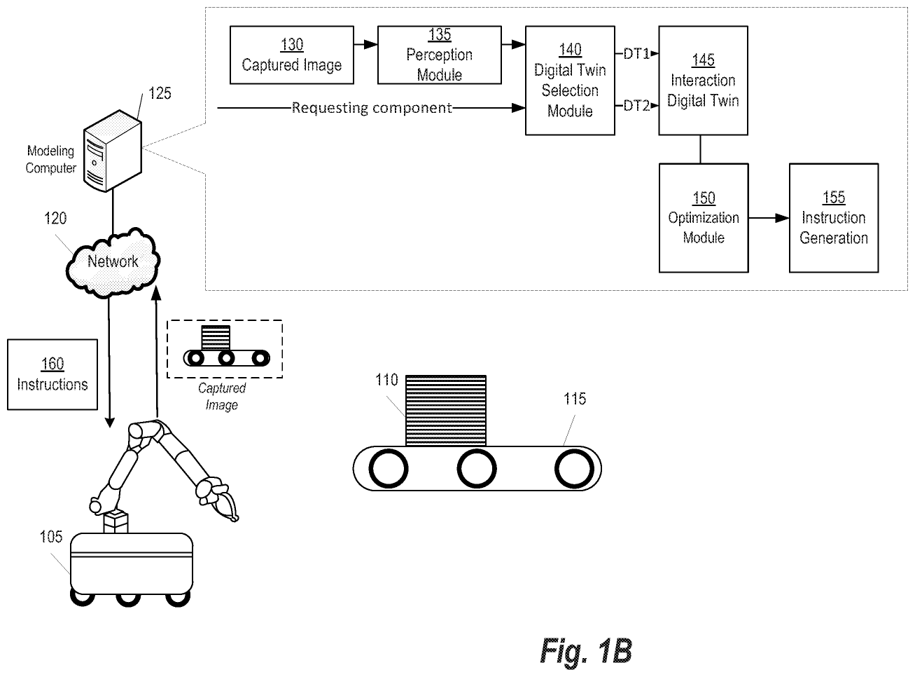

To illustrate the concepts described herein, FIG. 1A provides a simple example where a Robot 105 is tasked with picking up a Box 110 off a Conveyor Belt 115. Each component has a digital twin associated with it. The exact design and configuration of the digital twin can vary, but in the example of FIG. 1A, the digital twin comprises four modules. An electronics simulation module simulates the electrical devices in the component. For example, for the Robot 105, the electronics simulation may simulate various data associated with the motor. Similarly, the software simulation simulates any on-board software executed by the device. The digital twin also includes a structural mode module for representing the physical structure of the component, and a motion simulation module for simulating any motion of the device. It should be noted that each component need not implement every module. For example, the Box 110 may only have a structural model. It should also be noted that FIG. 1A overly simplifies the digital twin for illustration purposes. For example, additional interfaces for collecting and processing data may be included in each digital twin.

Although each digital twin is conceptually shown as being located at each component in FIG. 1A, in real world scenarios the digital twins can be collected at one or more computer systems, either local or remote to the production environment. For example, in one embodiment, data is collected from the Robot 105 and the Conveyor Belt 115 during the respective operations. This data can then be relayed over a network to a cloud-based computing server to update digital twins for the Robot 105 and the Conveyor Belt 115. For components that do not generate data, such as Box 110, the digital twin may simply not be updated with operations data or other sources of data outside of the component may be used to monitor its state. For example, with respect to the Box 110, one or more cameras or other sensors in the production environment can collect data on the state (e.g., location, position, etc.) of the Box 110 and relay that to the computing system hosting the digital twin of the Box 110.

FIG. 1B provides an overview of the interaction of system components which can be modeled using digital twins, according to some embodiments. Robot 105 uses an on-board computer to capture an image of Box 110 and Conveyor Belt 115. In other embodiments, as a supplement or alternative to a visual camera, other types of sensors may be used to gather information about the Box 110 and Conveyor Belt 115.

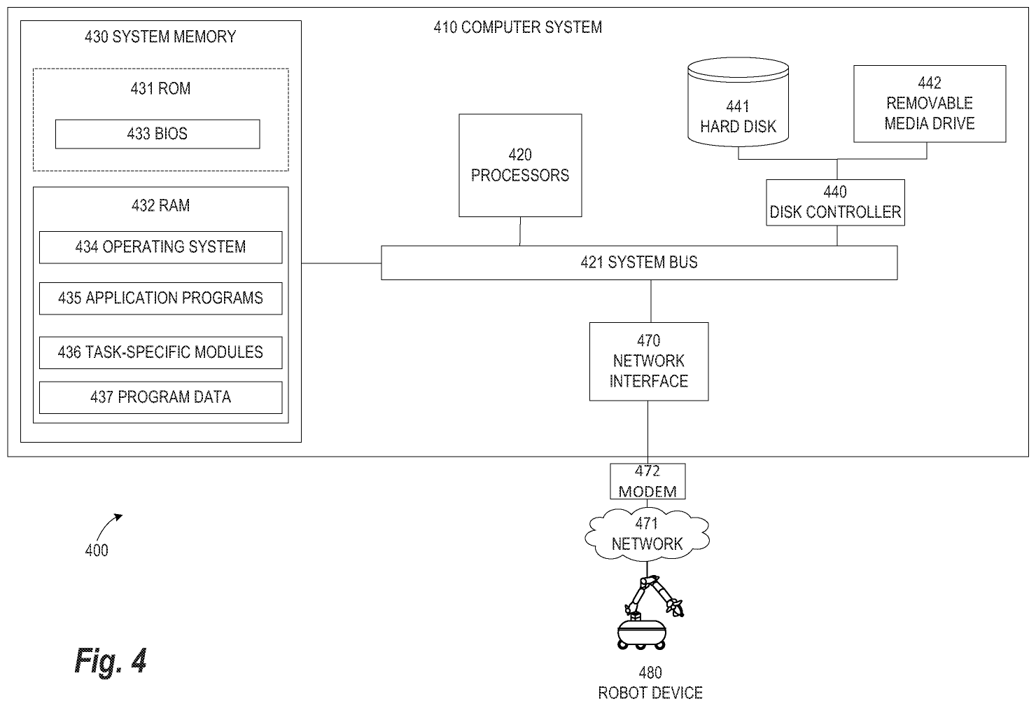

The captured image is sent over a Network 120 to a Modeling Computer 125. The Network can generally be any network known in the art including a local intranet or the Internet. One example of a Modeling Computer 125 is shown below in FIG. 4.

The Modeling Computer 125 uses the Captured Image 130 as input to a Perception Module 135. The Perception Module 135 applies one or more perception algorithm to detect objects in the Captured Image 130. In general, any perception algorithm known in the art may be employed. For example, for visual images, an only machine learning model such as the Google Cloud Vision API may be used. Given an image, Google Cloud Vision will identify the objects present in the image and provide some other contextual information. For example, given a picture of the production environment shown in FIG. 1, Google Cloud Vision may return “Box” and “Conveyor Belt.” It should be understood that Google Cloud Vision is only one example of a perception algorithm and other similar algorithms alternatively may be used.

The Perception Module 135 may perform additional analysis on the Captured Image 130 when multiple objects are present in the image as in FIG. 1B. In some cases, objects that cannot be interacted with directly are eliminated. For example, it is possible that the Robot 105 may be unable to interact with the Conveyor Belt 115 in any meaningful way. Thus, the Conveyor Belt 115 can be eliminated from consideration and the Box 110 alone can be used for further processing. In some embodiments, this knowledge can be encoded in a machine learning model such that knowledge of the requesting component (i.e., the Robot 105) can be used to decide which objects are relevant.

A Digital Twin Selection Module 140 identifies digital twins associated with the requesting component (i.e., the Robot 105) and the output of the Perception Module 135 (i.e., the Box 110). In embodiments where the digital twins are stored at the Modeling Computer 125, the digital twins themselves may be copied into active memory or their respective file locations can be identified. In other embodiments, where the digital twins are remote to the Modeling Computer 125, application programming interfaces (e.g., REST interfaces) to the components may be identified. An Interaction Digital Twin 145 uses the two component digital twins to simulate an interaction between the real-world components.

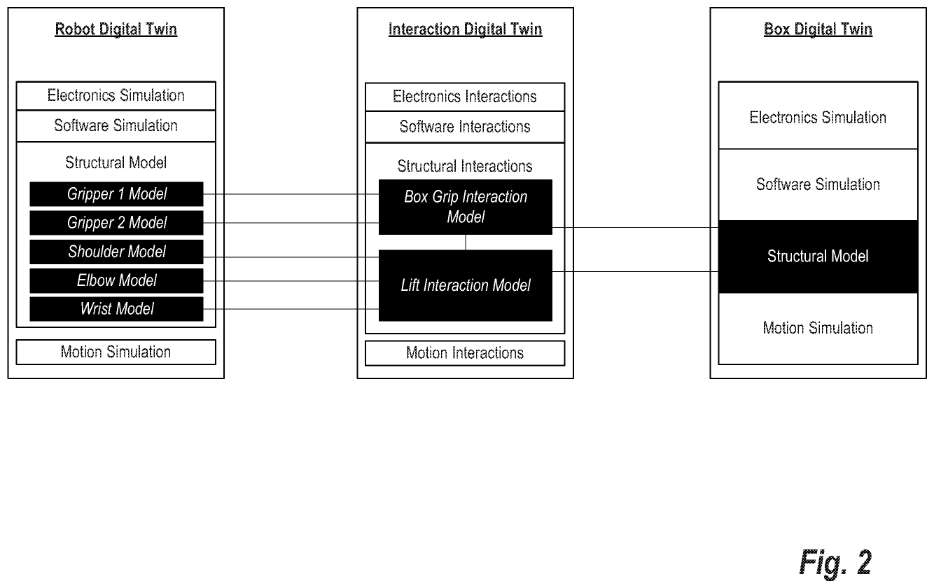

FIG. 2 illustrates an example of interaction digital twin, according to some embodiments. As shown in the figure, the structural models of the robot digital twin includes models for two grippers and the shoulder, elbow, and wrist segments of the robot's arm. For simplicity, it is assumed that the box digital twin only includes a structural model; however, it should be understood that more complicated structural models can be used in other embodiments, especially where the physical component itself is more complex. The gripper structural models and the box structural model are connected to a box grip interaction model that simulates the interaction of the gripper squeezing the box. The shoulder, elbow, and wrist models are connected to a lift interaction model that simulates the effect of lifting the box by the grippers. For example, the lift interaction model may simulate the stress on the robot arm from lifting a box of a given weight at different arm positions.

Returning to FIG. 1B, an Optimization Module 150 determines an optimal interaction by simulating a plurality of interaction scenarios with varying parameters (e.g., arm position, grip strength, etc.). In general any technique known in the art may be used for determining the optimal interaction. For example, in one embodiment, reinforcement learning is used with a reward system defined based on target states that minimize one or more characteristics (e.g., stress on component parts, time, cost, etc.). Reinforcement learning is defined in more detail below. Once the optimal interaction has been determined, an Instruction Module 155 generates Instructions 160 for the Robot 105 that allows it to perform its portion of the interaction.

Although FIGS. 1A, 1B, and 2 represent a relatively simple case, the general concept of the interaction digital twin can be scaled by hierarchically building more complex interactions. For example, an automobile includes a variety of subsystems including the engine, the fuel system, the exhaust system, the cooling system, the lubrication system, the electrical system, the transmission, and the chassis. Within each subsystem there are a variety of sub-components that interact with one another to enable vehicle operation. One way to use the interaction digital twin would be to have component-to-component interactions modeled with an interaction digital twin at the lowest level of the architecture. As the design proceeds to the higher layers, interaction digital twins may be combined. Thus, for example, once on the major system level, an interaction digital twin may be used to model the interaction between the engine and fuel system, based on the interactions of various sub-components. Moreover, the driver may also be modeled via a digital twin and interactions between the driver and the vehicle can be modeled using an interaction twin designed according to the techniques described herein.

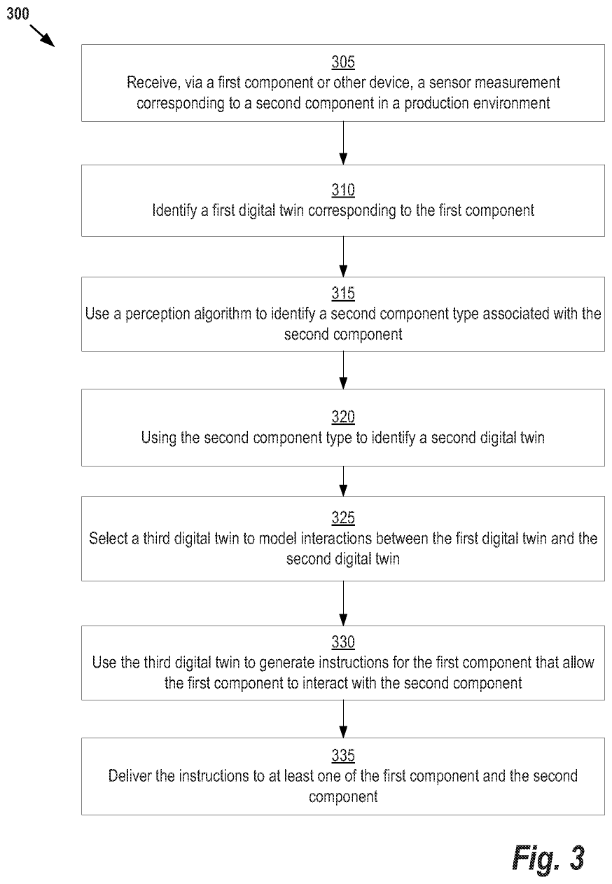

FIG. 3 illustrates an example method 300 for modeling interactions, according to some embodiments. This method may be performed, for example, by the one of the components in the production environment or another computer connected to the components over a network (e.g., Modeling Computer 125). In this example the interaction of a first component and second component is modeled. Starting at 305, the computer receives a sensor measurement corresponding to the second component. This sensor measurement may be received, for example, via one of the components, or another device in the production environment (e.g., an overhead camera). As explained below, the sensor measurements are used to identify a second component. To continue with the example discussed above, in some embodiments, the first component is a robot and the second component is a box or other workpiece. In general, any type of sensor measurements may be used that provide sufficient information for identifying the second component. For example, in one embodiment, the sensor measurement comprises an image captured by a camera installed on the first component. As an alternative to a visual image, in other embodiments, the sensor measurement comprises a point cloud captured by a camera installed on the first component. Other types of sensor measurements can also be employed such as auditory measurements, heat measurements, force measurements, etc.

At step 310, the computer system identifies a first digital twin corresponding to the first component. This identification may be performed, for example, as an identifier received from the first component (e.g., a field in the header of the packets transferring the sensor data). Based on this identification, the first digital twin can be retrieved (e.g., from a local database).

Next, at step 315, a perception algorithm is applied to identify a component type associated with the second component (as described above with regard to the Perception Module 135 in FIG. 1B). Once the component type is known, it is used at step 320 to select a second digital twin. Then, at step 325, a third digital twin is selected to model interactions between the first digital twin and the second digital twin. With the first component and second component identified, the selection of third digital twin can be effectively a simple lookup. For example, where the first component is known to be the robot and the second component is a box, the computer at step 325 simply needs to select the “robot-box” interaction digital twin. In some embodiments, additional details on the interaction may be used to provide further specificity to the interaction digital twin. For example, if the robot indicates that it wants to lift the box, a lift-specific robot-box interaction digital twin may be selected.

At step 330, the computer uses the third digital twin to generate instructions for the first component that allow the first component to interact with the second component. In some embodiments, the third digital twin models the interaction using a machine learning model trained using a plurality of interactions between the first component and second component. This machine learning model can be trained with a library of real-world interactions between the first component and second component. If there is not enough real-world data to support such training, synthetic data may be employed.

For example, in one embodiment, the interactions comprise a plurality of real world interactions and a plurality of synthetic interactions generated using a generative adversarial network trained using the real world interactions. Generative adversarial networks generally represent a class of artificial intelligence algorithms that falls under the category of unsupervised learning. In its simplest form, generative adversarial networks are a combination of two neural networks: one network is learning how to generate examples (e.g., synthetic interactions) from a training data set (e.g., real-world data describing the interactions) and another network attempts to distinguish between the generated examples and the training data set. The training process is successful if the generative network produces examples which converge with the actual data such that the discrimination network cannot consistently distinguish between the two.

In generative adversarial networks, training examples consist of two data sets X and Y. The data sets are unpaired, meaning that there is no one-to-one correspondence of the training images in X and Y. The generator network learns how to generate an image y′ for any image x in the X data set. More particularly, the generator network learns a mapping G:X→Y which produces an image y′ (y′=G(x)). The generator network trains the mapping G:X→Y such that y′ is indistinguishable from y by a discriminator network trained to distinguish y′ from y. In other words, the generator network continues producing examples until the discriminator network cannot reliably classify the example as being produced by the generator network (y′) or supplied as an actual example (y).

Once the training data is generated, the machine model can be trained. The exact method of training will depend on the model used. For example, in other embodiments, the machine learning model may be one or more recurrent neural networks (RNNs). For example, in some embodiments, the third digital twin models the interaction as an order series of interaction states and each interaction state comprises a first configuration corresponding to the first component and a second configuration corresponding to the second component. Each state comprises data from the first and second digital twin that describes their respective positions, forces being exerted or applied upon, etc. For example, for a robot component, the state information may include the position of the various components of the arm, the grippers, the force being exerted on the arm due to what is being held in the grippers, etc. In this way a RNN can be used to directly estimate the interaction state based on data from the first digital twin and the second digital twin. For example, in one embodiment, the RNN model is designed with two layers. The first layer is a long short-term memory (LSTM) model receiving the data from the first digital twin and the second digital twin and generating internal ouput data. The second layer is LSTM model receiving the internal ouput data and estimating the interaction states.

In other embodiments, the machine learning model is a deep reinforcement learning model. General deep learning techniques are conventionally applied to various problems ranging from image classification, object detection and segmentation, and speech recognition to transfer learning. Deep learning is the automatic learning of hierarchical data representations describing the underlying phenomenon. That is, deep learning proposes an automated feature design by extracting and disentangling data-describing attributes directly from the raw input in contrast to feature handcrafting. Hierarchical structures encoded by neural networks are used to model this learning approach.

Some embodiments use deep learning in conjunction with Reinforcement Learning (RL). RL facilitates learning as an end-to-end cognitive process for an artificial agent, instead of a predefined methodology. One RL setting is composed by an artificial agent that can interact with an uncertain environment (e.g., a request to acquire image data with limited or no parameters) with the target of reaching pre-determined goals (e.g., acquiring the image with the optimal parameters). The agent can observe the state of the environment and choose to act on the state, similar to a trial-and-error search, maximizing the future reward signal received as a response from the environment. The environment may be modeled by simulation or operators which gives positive and negative rewards to the current state.

An optimal action-value function approximator Q* estimates the agent's response to an image acquisition parameterized by state space sₜ. in the context of a reward function rₜ. This reward-based decision process is modeled in RL theory as a Markov Decision Process (MDP) defined by a tuple M:=S, A, T, R, γ, where S is a finite set of states and sₜϵS is the state of the agent at time t. A is a finite set of actions allowing the agent to interact with the environment, and aₜϵA is the action the agent performs at time t. T:S×A×S→[0; 1] is a stochastic transition function, where T_{s,a}^{s}′ is the probability of arriving in state s′ after the agent performed action a in state s. R:S×A×S→ [symbol] is a scalar reward function, where R_{s,a}^{s}′ is the expected reward after a state transition. γ is the discount factor controlling the importance of future versus immediate rewards.

The future discounted reward of an agent at time \hat{t} can be written as R_{\hat{t}}=Σ_{t=\hat{t}}^{T}γ^{t-\hat{t}}rₜ, with T marking the end of a learning episode and rₜ defining the immediate reward the agent receives at time t. In model-free reinforcement learning, the target may be used to find the optimal so called “action-value function,” which denotes the maximum expected future discounted reward when starting in state s and performing action a as:

$${Q}^{*} ( s , a ) = {max}_{π} 𝔼 [ {R}_{t} \vert {s}_{t} = s , {a}_{t} = a , π ]$$

where π is an action policy. That is, the action policy is a probability distribution over possible actions in each given state. Once the optimal action-value function is estimated, an optimal action policy determining the behavior of the agent can be directly computed in each state as:

$${∀}_{s} ∈ S : {π}^{*} ( s ) = {argmax}_{a ∈ A} {Q}^{*} ( s , a )$$

The optimal action-value function approximator Q* is the Bellman optimality equation, representing a recursive formulation of Q*(s, a)=, defined as:

$${Q}^{*} ( s , a ) = {\sum }_{{s}^{′}} {T}_{s , a}^{{s}^{′}} ( {R}_{s , a}^{{s}^{′}} + γ {max}_{{a}^{′}} {Q}^{*} ( {s}^{′} , {a}^{′} ) )$$

where s′ defines a possible state visited after s, a′ the corresponding action and r=R_{s,a}^{s′} represents a compact notation for the current, immediate reward. Viewed as an operator τ, the Bellman equation defines a contraction mapping. Applying Qᵢ₊₁=τ(Qᵢ), ∀(s, a), the function Qᵢ converges to Q* at infinity. This standard, model-based policy iteration approach may, however, not be feasible in practice. An alternative is the use of model-free temporal difference methods, typically Q-Learning, which exploits correlation of consecutive states, in practice. Using parametric functions to approximate the Q-function furthers a goal of higher computational efficiency. Considering the expected non-linear structure of the action-value function, neural networks represent a sufficiently powerful approximation solution.

In the context of the present invention, as implmented in some embodiments, the artificial agent is part of the interaction digital twin and may learn the optimal action-value function approximator based on interaction states observed over time, as well as synthetic interaction data. This data may include both successful interactions, and well as unsuccessful ones. To continue with the robot moving a box example, interactions may be used where the box is moved by the robot at various speeds, arm angles, etc. Additionally, “unsuccessful” cases where the box was damaged or dropped by the robot may also be used. Moreover, in some embodiments, stress levels of interactions can be monitored (e.g., by a designer or operator), and interactions that overly stress the components can be deemed “unsuccessful.” This process can be automated or semi-automated by defining threshold values for various parts of each component, and marking an interaction as “unsuccessful” if any of the thresholds are exceeded.

Returning to FIG. 3, at step 335 the computer delivering the instructions to at least one of the first component and the second component. With interaction states fully known, generating the instructions is just a matter of translating the states into instructions executable by the components. The exact method of translation may vary depending on the capabilities of the component and how it requires instructions to be specified. For example, in some embodiments, a series of explicit instructions is generated (e.g., “move arm 10 degrees, engage grippers with force between 90 and 110 Newtons, etc.”). This translation may be performed at the computer performing the method 300, or another computer in the system may generate the instructions. As the interaction is actually performed by the first component and second component, their respective digital twins can be continuously monitored to gather further real-world information that can be used to further train the machine learning model of the interaction digital twin.

FIG. 4 illustrates an exemplary computing environment 400 within which the Modeling Computer 125 (shown in FIG. 1B) may be implemented. The computing environment 400 includes computer system 410, which is one example of a computing system upon which embodiments of the invention may be implemented. Computers and computing environments, such as computer system 410 and computing environment 400, are known to those of skill in the art and thus are described briefly herein.

As shown in FIG. 4, the computer system 410 may include a communication mechanism such as a bus 421 or other communication mechanism for communicating information within the computer system 410. The computer system 410 further includes one or more processors 420 coupled with the bus 421 for processing the information. The processors 420 may include one or more central processing units (CPUs), graphical processing units (GPUs), or any other processor known in the art.

The computer system 410 also includes a system memory 430 coupled to the bus 421 for storing information and instructions to be executed by processors 420. The system memory 430 may include computer readable storage media in the form of volatile and/or nonvolatile memory, such as read only memory (ROM) 431 and/or random access memory (RAM) 432. The system memory RAM 432 may include other dynamic storage device(s) (e.g., dynamic RAM, static RAM, and synchronous DRAM). The system memory ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system (BIOS) 433 contains the basic routines that help to transfer information between elements within computer system 410, such as during start-up, may be stored in ROM 431. RAM 432 may contain data and/or program modules that are immediately accessible to and/or presently being operated on by the processors 420. System memory 430 may additionally include, for example, operating system 434, application programs 435, task-specific modules 436 and program data 437. The application programs 435 may include, for example, one or more executable applications that enable retrieval of one or more of the task-specific modules 436 in response to a request received from the Robot Device 480.

The computer system 410 also includes a disk controller 440 coupled to the bus 421 to control one or more storage devices for storing information and instructions, such as a hard disk 441 and a removable media drive 442 (e.g., compact disc drive, solid state drive, etc.). The storage devices may be added to the computer system 410 using an appropriate device interface (e.g., a small computer system interface (SCSI), integrated device electronics (IDE), Universal Serial Bus (USB), or FireWire).

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium, such as a hard disk 441 or a removable media drive 442. The hard disk 441 may contain one or more datastores and data files used by embodiments of the present invention. For example, in some embodiments, the hard disk 441 may be used to store task-specific modules as an alternative or supplement to the RANI 432. Datastore contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processor 420 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 441 or removable media drive 442. Non-limiting examples of volatile media include dynamic memory, such as system memory 430. Non-limiting examples of transmission media include coaxial cables, copper wire, and fiber optics, including the wires that make up the bus 421. Transmission media may also take the form of acoustic or light waves, such as those generated during radio wave and infrared data communications.

When used in a networking environment, computer system 410 may include modem 472 for establishing communications with a Robot Device 480 or other remote computing system over a network 471, such as the Internet. Modem 472 may be connected to bus 421 via user network interface 470, or via another appropriate mechanism. It should be noted that, although the Robot Device 480 is illustrated as being connected to the computer system 410 over the network 471 in the example presented in FIG. 4, in other embodiments of the present invention, the computer system 410 may be directly connected to the Robot Device 480. For example, in one embodiment the computer system 410 and the Robot Device 480 are co-located in the same room or in adjacent rooms, and the devices are connected using any transmission media generally known in the art.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., Robot Device 480). The network 471 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

The general architecture of the computer system 410 may be used to implement the internal computing system of the Robot Device 480. In some embodiments, the various components of the computer system 410 described above can be used in a simplified form. For example, the Robot Device 480 may use a single processor and a relatively small amount of system memory 430. Additionally, components such as the hard disk 441 and removable media drive 442 may be omitted. Furthermore the Robot Device 480 may store additional data such as machine-specific modules to enable its performance of the techniques described herein. It should be understood that the component does not need to be a robot device and, in other embodiments, other types of computing devices may be similarly connected via the Network 471.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Unless stated otherwise as apparent from the following discussion, it will be appreciated that terms such as “applying,” “generating,” “identifying,” “determining,” “processing,” “computing,” “selecting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) the element is expressly recited using the phrase “means for.”

We claim:

1. A method comprising:
receiving, via a first component in a production environment, a sensor measurement corresponding to a second component in the production environment;
identifying a first digital twin corresponding to the first component;
applying a perception algorithm to identify a component type associated with the second component;
selecting a second digital twin based on the component type;
selecting a third digital twin modeling interactions between the first digital twin and the second digital twin;
using the third digital twin to generate instructions for the first component that allow the first component to interact with the second component; and
delivering the instructions to the first component.

2. The method of claim 1, wherein the sensor measurement comprises an image captured by a camera installed on the first component.

3. The method of claim 1, wherein the sensor measurement comprises a point cloud captured by a camera installed on the first component.

4. The method of claim 1, wherein the first component is a robot and the second component is a workpiece.

5. The method of claim 1, wherein third digital twin models interaction between the first component and the second component using a machine learning model trained using a plurality of interactions between the first component and second component.

6. The method of claim 5 wherein the interactions comprise a plurality of real interactions and a plurality of synthetic interactions generated using a generative adversarial network trained using the plurality of real interactions.

7. The method of claim 6, wherein the machine learning model is a deep reinforcement learning model utilizing a reward system which provides positive reinforcement for interactions yielding one or more target states where one or more stress levels are associated with the first component are below predetermined limits.

8. The method of claim 6, wherein the third digital twin models the interaction as an order series of interaction states and each interaction state comprises a first configuration corresponding to the first component and a second configuration corresponding to the second component.

9. The method of claim 8, wherein the machine learning model comprises one or more recurrent neural network (RNN) models that directly estimate the interaction state based on data from the first digital twin and the second digital twin.

10. The method of claim 9, wherein the one or more RNN models comprise (a) a first layer long short-term memory (LSTM) model receiving the data from the first digital twin and the second digital twin and generating internal ouput data and (b) a second layer LSTM model receiving the internal ouput data and estimating the interaction states.

11. A system comprising:
a first digital twin corresponding to a first component in a production environment;
a second digital twin corresponding to a second component in the production environment;
a third digital twin modeling interactions between the first component and the second component using the first digital twin and the second digital twin.

12. The system of claim 11, wherein the first component is a robot and the second component is a workpiece.

13. The system of claim 11, wherein third digital twin models interaction between the first component and the second component using a machine learning model trained using a plurality of interactions between the first component and second component.

14. The system of claim 13, wherein the interactions comprise a plurality of real interactions and a plurality of synthetic interactions generated using a generative adversarial network trained using the plurality of real interactions.

15. The system of claim 14, wherein the machine learning model is a deep reinforcement learning model utilizing a reward system which provides positive reinforcement for interactions yielding one or more target states where one or more stress levels are associated with the first component are below predetermined limits.

16. The system of claim 14, wherein the third digital twin models the interaction as an order series of interaction states and each interaction state comprises a first configuration corresponding to the first component and a second configuration corresponding to the second component.

17. The system of claim 16, wherein the machine learning model comprises one or more recurrent neural network (RNN) models that directly estimate the interaction state based on data from the first digital twin and the second digital twin.

18. The system of claim 17, wherein the one or more RNN models comprise (a) a first layer long short-term memory (LSTM) model receiving the data from the first digital twin and the second digital twin and generating internal ouput data and (b) a second layer LSTM model receiving the internal ouput data and estimating the interaction states.

19. A system for modeling interactions between a first component and a second component in a production environment, the system comprising:
a perception module receiving sensor data from the first component and identifying the second component based on the sensor data;
a digital twin selection module selecting a first digital twin corresponding to the first component and second digital twin corresponding to the second component;
an interaction digital twin modeling interactions between the first component and the second component using the first digital twin and the second digital twin; and
an optimization module identifying an optimal interaction between the first and second component using the interaction digital twin.
